(19) United States
(12) Patent Application Publication
(10) Pub. No.: US 2019/0043378 A1
(43) Pub. Date: Feb. 7, 2019

(54) MOBILE PLATFORM FOR AUTOMATIC GENERATION OF PERSONALIZED CHALLENGES AND EDUCATIONAL MATERIALS

(71) Applicant: Habitz, Inc., San Jose, CA (US)

(72) Inventors: Daniel Fishkov, San Jose, CA (US); Yael Dror Saroussi, Ashdod (IL); Morris Michael, Sunnyvale, CA (US)

(21) Appl. No.: 16/053,744

(22) Filed: Aug. 2, 2018

Related U.S. Application Data
(60) Provisional application No. 62/540,558, filed on Aug. 2, 2017.

(51) Int. Cl. G09B 7/00

(52) U.S. Cl. CPC G09B 7/00

(57) ABSTRACT

Disclosed herein are systems and methods for automatic generation of personalized challenges, incentives, and educational material for a user based on global objectives, personal characteristics, and past activity of the user, among other factors.

### CROSS-REFERENCE TO RELATED APPLICATIONS

This patent application claims priority to and the benefit of U.S. Provisional Patent Application No. 62/540,558, filed Aug. 2, 2017, which is incorporated herein by reference as if set forth in its entirety.

### TECHNICAL FIELD

The present disclosure generally relates to the field of mobile platforms and applications.

### BACKGROUND

As smartphones, smartwatches, and other mobile devices are becoming commonplace and as the number of mobile applications is growing exponentially, a growing number of people are beginning to use their mobile devices in ways that allow them to better organize and optimize their busy lives. It is also not uncommon for children to own or have access to mobile devices, but most mobile applications developed for children are gaming or social-network applications. A small percentage of children applications are educational in nature, but such applications are usually geared only toward improving children's academic skills and are not designed in a way that would really incentivize them to learn the material and implement it in their daily lives.

### SUMMARY

Various embodiments discussed in the present disclosure relate to systems and methods enabling, among other things, automatic generation of personalized challenges, incentives, and educational material for a particular user based on a set of objectives defined for that user, the user's characteristics, user's past activity, past activity of other (e.g., similar) users, and various other factors.

### BRIEF DESCRIPTION OF THE DRAWINGS

The following detailed description references the drawings, wherein:

FIG. 1 shows an exemplary system comprising an exemplary server, an exemplary child database, and exemplary mobile devices, in accordance with some embodiments;

FIGS. 2A-2H illustrate various exemplary user interfaces of a mobile device running a mobile app associated with a child user;

FIG. 3 shows a high level workflow diagram of an exemplary method that can be performed, for example, by the mobile app associated with the child user; and

FIG. 4 illustrates an exemplary user interface of a mobile device running an instance of a mobile app associated with a parent user.

### DETAILED DESCRIPTION

Embodiments disclosed herein describe, among other things, a server system. The server system may include, for example a challenge generator configured to generate a set of daily challenges for a child user based at least on i) a set of global objectives defined for the child user by a parent user associated with the child user, and ii) past activity data associated with the child user. The server system may also include an educational material selector configured to select for the child user at least one educational material from a set of educational materials based on at least one of a) the set of global objectives and b) the past activity data, and optionally associate the educational module with at least one of the set of daily challenges. The server system may also include an application server engine configured to send the selected educational material and the generated set of daily challenges to a first computing device running a first instance of a client application, the first instance of the client application being accessible by the child user, and obtain from the first computing device activity data of the child user, where at least some of the activity data corresponds to the set of daily challenges and/or the selected educational material.

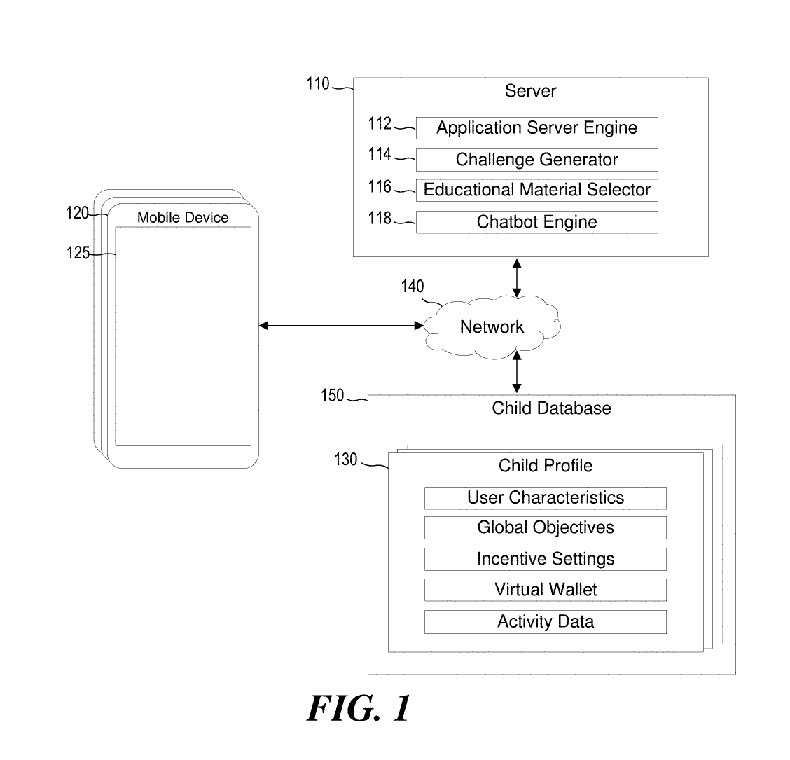

FIG. 1 is a block diagram of an exemplary system 100 in accordance with some embodiments. System 100 may include, among other things, a server 110, one or more mobile devices 120, and a user database 150, all communicating (in some embodiments) via network 140.

Network 140 may comprise any combination of one or more wired, wireless, local-area, or wide-area networks (e.g., the Internet), and may include any number of hubs, routers, switches, cell towers, etc.

User database 150 may include one or more databases stored on a single device or distributed over multiple devices (e.g., servers) connected to each other and to various elements of system 100 either directly or through one or more wired or wireless networks. The one or more databases can include any type of non-volatile memory devices, such as flash memories, hard drives, random-access memories, read-only memories, or any combination thereof. While user database 150 is depicted as a separate block in FIG. 1, it is appreciated that in various embodiments, various parts of user database 150 may be stored on one or more mobile devices 120 and/or on server 110. For example, some data related to a particular user may be stored on that user's mobile device 120. Furthermore, some data may be duplicated and stored on multiple devices to provide backup and/or to speed up access to that data. In some embodiments, user database 150 may include, among other things, a plurality of child profiles 130, where each child profile 130 corresponds to and include data associated with a specific child user, as discussed in more detail below.

Server 110, while depicted for brevity as a single device, can include one or more computing devices of any type. Thus, server 110 may comprise one or more processors and one or more non-volatile computer-readable memories storing instructions which, when executed by the one or more processors, cause server 110 to execute various operations described in more details below. The one or more computing devices comprising server 110 can be physically located at the same location (e.g., same data center) or distributed over multiple locations. In some embodiments, each of the computing devices comprising server 110 may be connected to each other and to various elements of system 100 via network 140. For example, one or more computing devices comprising server 110 may be located on a “cloud,” such as the Amazon's AWS cloud platform, Microsoft's Azure cloud platform, or any other suitable platform. Server 110 may include one or more engines or modules configured to implement various portions of the functionality of server 110 described below. In the exemplary embodiment illustrated in FIG. 1, server 110 includes an application server engine 112, a challenge generator 114, an educational material selector 116, and a chatbot engine 118. The functionalities of these modules (described in more detail below) can be implemented using any combination of hardware, software, or firmware. It is appreciated that in various embodiments, various modules can be combined into the same module and/or divided into submodules. It is also appreciated that in various embodiments, some modules of server 110 depicted in FIG. 1 can be omitted, and that server 110 can include additional modules not depicted in FIG. 1 for brevity.

Each mobile device 120 may be a smartphone, a tablet computer, a wearable device (e.g., a smart watch), a laptop computer, or any other type of electronic device or combination of electronic devices. Each mobile device 120 may comprise one or more processors (e.g., central processing units (CPUs), semiconductor-based microprocessors, graphics processing units (GPUs), field-programmable gate arrays (FPGAs), etc.) and one or more memories (e.g., random-access memory (RAM), flash memory, hard drive, or any other volatile or non-volatile non-transitory machine-readable medium). The one or more memories can store instructions which, when executed by the one or more processors, can cause mobile device 120 to execute various operations described in more details below. In some embodiments, the instructions can be downloaded by mobile device 120 from one or more remote application servers. Mobile device 120 may also include or be communicatively coupled to a display 125, which may include any type of display, such as a light-emitting diode (LED) display, an organic LED (OLED) display, and the like. In some embodiments, display 122 may be a touch-sensitive display.

In some embodiments, each mobile device 120 may be configured to store and/or execute a mobile application (e.g., an iOS application or an Android application), referred to hereinafter as “the mobile app.” In some embodiments discussed herein, the mobile app can be configured to present different user interfaces depending on who is using the app. For example, in some embodiments, a user can download, install, and run the mobile app, after which the parent user can then create a new parent account. In some embodiments, creating a parent user account may require that the user verify his or her age and/or identity. The verification may include, for example, providing the user's name, billing and/or mailing address, credit card information, and any other required information. After creating a new parent account, the user can at any time log into the mobile app using the user credentials (e.g., username/email and password). In some embodiments, when a user logs in using parent account credentials, that user is automatically considered a “parent user” and is shown a parent user interface (UI).

In some embodiments, a parent user can create, through the parent UI, one or more child accounts to be associated with the parent user's account. It should be noted that the various systems and methods described herein are not only applicable to parents and their children. Instead, the terms “parent user” and “child user” as used herein can refer to any two people associated by the functionality described below. That is, a parent user can be any user who is interested in setting objectives for the child user and providing incentives that would help the child user progress toward the set objectives, as described in more detail below. Thus, a parent user can be, for example, any type of a caregiver (e.g., a parent, a teacher, a doctor, a babysitter, or a coach), whereas the child user can be someone for whom the caregiver is responsible (e.g., the caregiver's child, elderly relative, student, patient, or athlete). For reasons of brevity, however, some examples below refer to parent users as being the parents of child users.

Each child account created by the parent user can be automatically associated with the parent user's parent account. In some embodiments, upon or after creating a new child account, the parent user can provide user characteristics for the new child user. The user characteristics may include, for example, the child user's name/username/nickname, password or PIN number, age (exact or approximate), gender, child user's preferences, profile picture, and any other relevant information that the parent user is willing to provide. Child user's preferences may include, for example, his or her nutritional preferences, such as whether or not the child user is a picky eater, what types of food the child loves (e.g., fruits, foods rich in carbohydrates, etc.), what types of food the child refuses to eat (e.g., vegetables, eggs, etc.), what types of food the child eats too much (e.g., sweets, sugary drinks, etc.), and other types of nutritional preferences. In some embodiments, as part of the user characteristics for the child user, the parent user can also specify the child's nutritional restrictions such as any known food allergies or intolerances the child has. In some embodiments, nutritional preferences and/or nutritional restrictions can be defined by the parent user using general categories (e.g., vegetables, dairy, carbohydrates, etc.) In other embodiments, the parent user can be presented with a detailed list of various foods or products (e.g., organized by general categories), in which case the parent user can define the nutritional preferences and/or nutritional restrictions by going through the detailed list and manually selecting or deselecting specific foods or products that the child user dislikes, likes, eats too much of, is allergic to, and so on.

In some embodiments, the parent user can also define their high-level/general objectives for each child account associated with that user. Such objectives are referred to herein as “global objectives.” In some embodiments, the parent user can define global objectives by selecting them from a predefined list of possible global objectives. Such list may include nutritional objectives such as “reduce sugar consumption” (or more specific: “eat less candy/sweets”), “eat more vegetables,” “avoid junk food,” “drink more water,” etc. The list may also include non-nutritional objectives such as general health objectives (e.g., “exercise more” or “regularly take X,” where X can be a particular supplement or prescribed medication can be manually entered and/or selected by the parent user from a list of predefined values), general behavioral or educational objectives (e.g., “go to bed on time,” “read more books,” “clean one's room,” “practice instrument X daily,” or “practice language X daily” where X can be manually entered and/or selected by the parent user from a list of predefined values), and so on. In some examples, the parent user may be able to customize some objectives on the predefined list of possible global objectives, e.g., by specifying the particular instrument or language to practice, the particular supplement or medication to take, or adjusting any other parameter that can be adjusted. Furthermore, in some embodiments, instead of or in addition to selecting objectives from the predefined list, the parent user can add new custom objectives. As illustrated in the examples above, some global objectives can be defined very broadly while other global objectives can be defined very specifically. Also, some global objectives can be defined positively (i.e., “do X” or “do more X”) while other global objectives can be defined in the negative (i.e., “do not do Y” or “do less of Y”).

In some embodiments, the parent user can also define incentive settings for each child user. Incentive settings can include, for example, a total incentive value per a defined period of time (e.g., per day, per week, per month, etc.), where the value can be defined as a monetary amount (e.g., in US dollars, Euros, or any other currency that can be automatically determined based on the mobile's phone location) or as a number of points that can be translated into a monetary amount using a known predefined conversion rate or any other formula. The total incentive value can define, for example, the maximum amount that the parent user is willing to spend on the particular child user during the defined period of time. In other embodiments, instead or in addition to defining the total incentive value, the parent user may provide input defining (either explicitly or implicitly, e.g., through a conversion ratio) the monetary value of each point accrued by the child user.

In some embodiments, the parent user can be presented with a list of all possible daily challenges (also referred to herein as daily “challenge items”) that could potentially be generated and given to the child user based on various other factors discussed in more detailed below. In some cases, the parent user can prioritize the possible daily challenges and specify which daily challenges the parent user considers to be more important or more effective than others for the particular child user. In some embodiments, the parent user can prioritize the challenges, for example, by assigning different incentive multipliers (e.g., 0.5×, 0.8×, 1.3×, 2×, 3×, etc.) to different challenges, where the multiplies would increase or decrease the number of points associated with those challenges. In some embodiments, the parent user can also remove some potential daily challenges from the list of challenges or otherwise mark them as challenges not to be used for the particular child user. Furthermore, in some embodiments the parent user can also add new, custom challenges to be given to the child user every day (or randomly once in several days) and provide incentive values to be associated with those challenges.

In some embodiments, the parent user can also review a list of rewards that would be available to the child, where each reward can be associated with a reward value corresponding, for example, to the number of incentive points that the child needs to accrue in order to request that reward. The parent user can remove some rewards from the list or otherwise mark those rewards as unavailable to the child user, even if the child user accrues the required number of points.

In some embodiments, any or all of the information provided by the parent user when the parent user creates the new parent account and one or more child accounts can be collected by the mobile app running on mobile device 120 through the parent user interface and provided to application server engine 112 of server 110 through network 140. Application server engine 112 can create in user database 150 a new child profile 130 for the new child account, and store all the above-described information provided by the parent user for the child user in the new child profile 130.

In some embodiments, after a child account is created by the parent user, a child user can access that account through the same mobile app running on the same mobile device 120 or by downloading, installing, and running another instance of the same mobile app on a different (e.g., child's own) mobile device 120. The child user can log into the mobile app, for example, using credentials (e.g., username and password) provided to him or her by the parent user. In some embodiments, the credentials required for a user to log into the mobile app as a child user are different than the credentials required to log into the mobile app as a parent user. For example, the latter can require different or additional credentials (e.g., an additional PIN code).

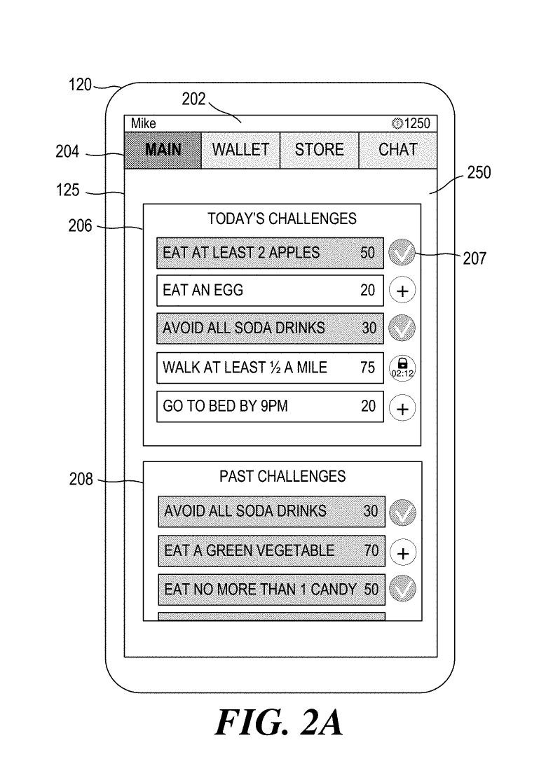

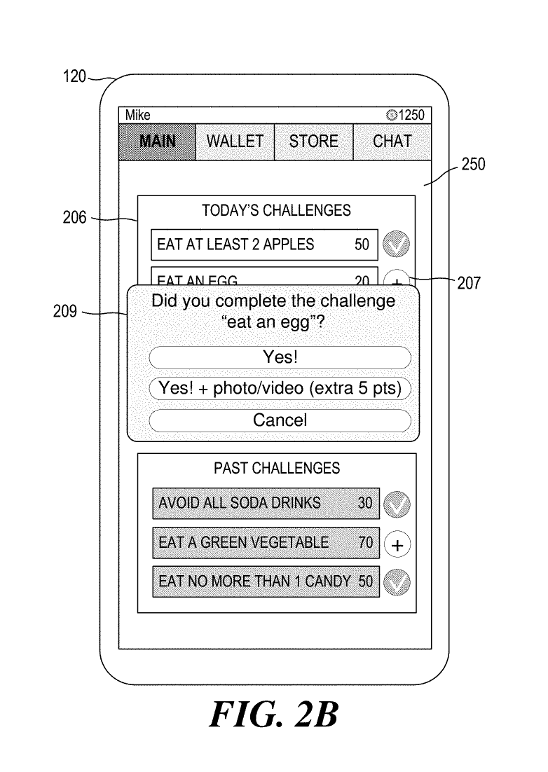

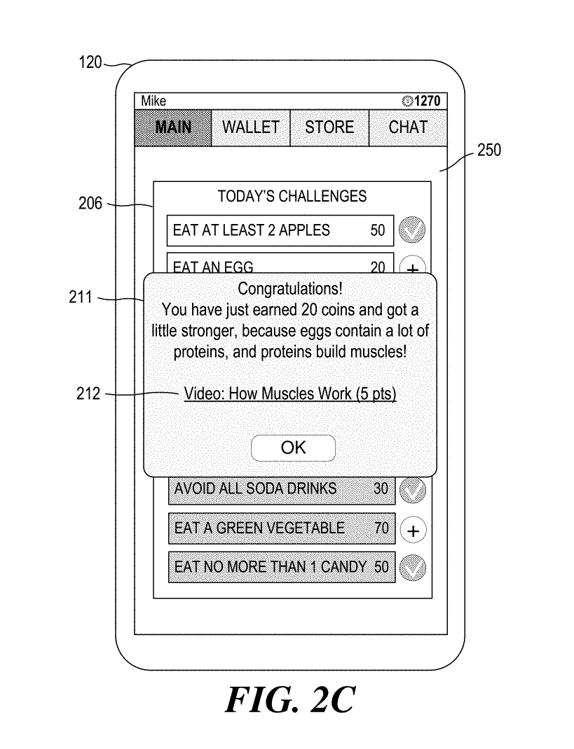

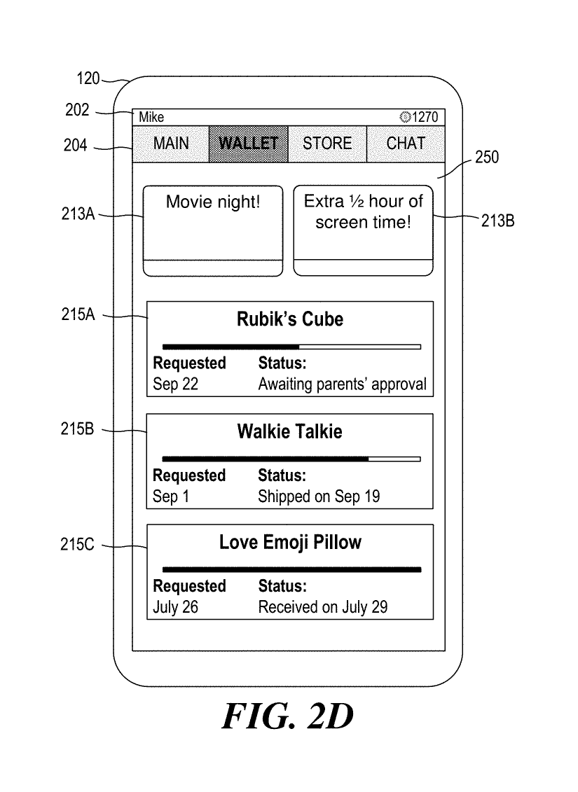

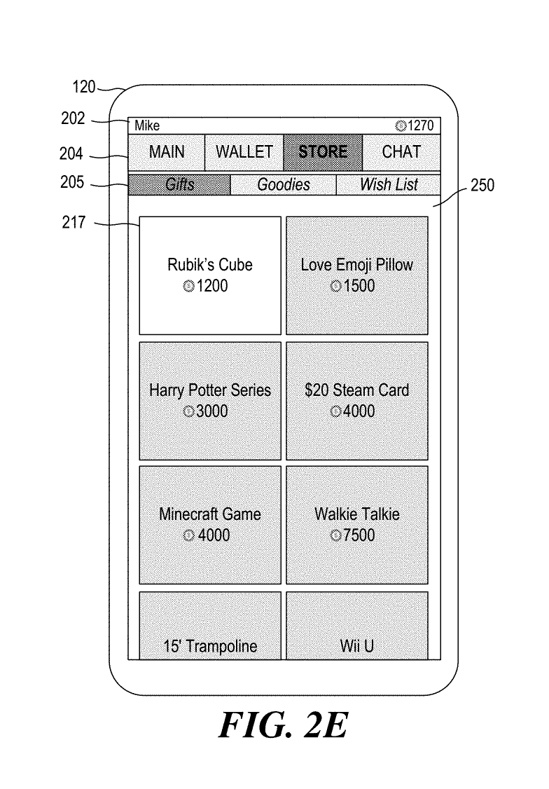

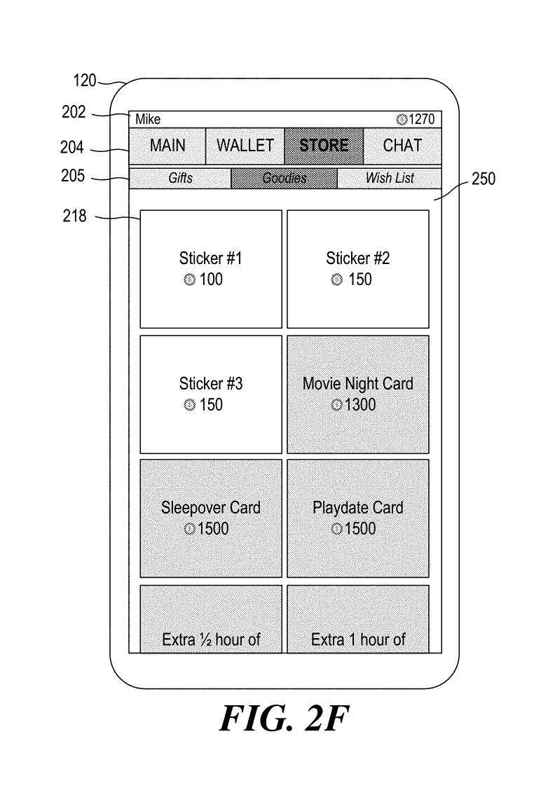

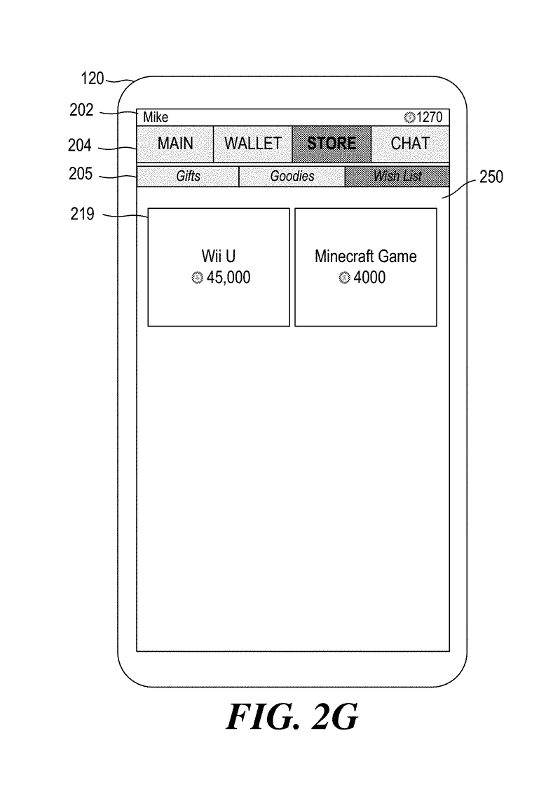

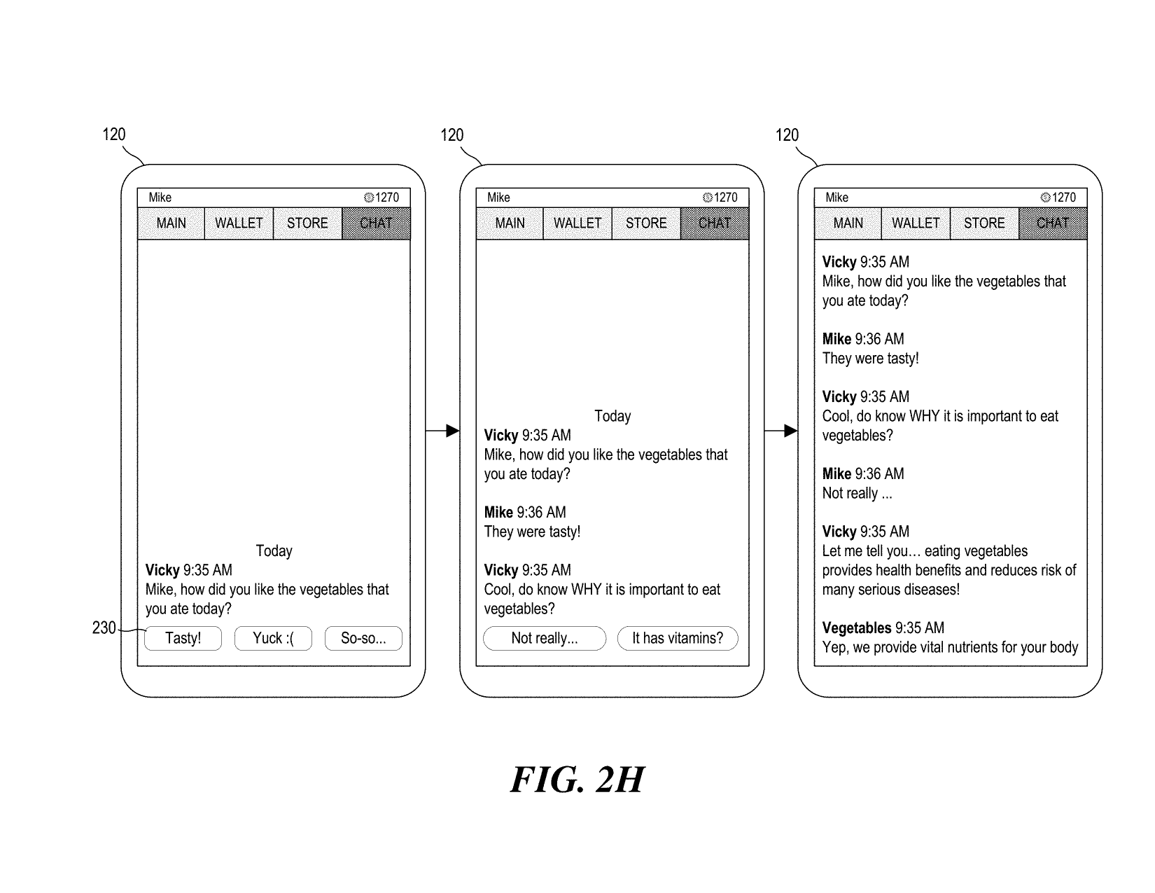

In some embodiments, upon logging into the mobile app as a child user, the child user can see a different user interface than the one seen by the associated parent user. FIG. 2A illustrates an example child user interface 250 presented to a child user on display 125 of child user's mobile device 120. As illustrated in FIG. 2A, the child user interface may include a status window 202 indicating the child user's name, username, or nickname, and the total number of points accrued by the child user so far. The child user interface may also include a plurality of tabs 204 allowing the child user to switch between various screens of the child user interface (e.g., “main,” “wallet,” “store,” and “chat”).

FIG. 2A shows an exemplary “main” screen, which may include a set of one or more “today's challenges” 206 and a set of one or more past challenges 208. In some embodiments, the set of challenges may have a fixed and predefined number of challenges (e.g., 10), while in other embodiments the set of challenges may be flexible and may change from one day to another.

As depicted in FIG. 2A, each challenge may include a description (e.g., “eat at least two apples”), a number of points that would be accrued if the challenge is accomplished (e.g., 50), and a widget 207 allowing the child user to select the challenge and mark it as accomplished. In some embodiments, each challenge may be associated with the same (predefined) number of points (e.g., 1, 10, etc.) in which case the number of points may not need to be shown next to each challenge.

In some embodiments (not shown in FIG. 2A for brevity) each challenge may also include a motivation clause explaining the motivation behind the challenge. For example, a challenge described as “Avoid chocolate” may be accompanied by a motivation clause “It can lead to tooth decay.” Furthermore, in some embodiments (not shown in FIG. 2A for brevity) a unique icon may be shown next to each challenge, representing either the particular challenge or the category (e.g., food, exercise, education, etc.) of the particular challenge.

In some embodiments, a particular challenge may be associated with a specific timeframe, where the challenge may be locked and unavailable for selection at certain times (e.g., before a certain time of the day and/or after a certain time of the day).

In some embodiments, past challenges 208 and today's challenges 206 that have already been accomplished may be displayed for information only and can no longer be selected by the child user. In some embodiments, at a certain time of a day (e.g., at midnight or after a predefined bedtime such as 9:30 PM) all today's challenges 206 can be re-designated as past challenges 208.

In some embodiments, at the same time of the day, or at a different time of the day (e.g., 8 AM of the following day), new set of daily challenges 206 can be generated by challenge generator 114, provided to child user's mobile device 120, and displayed as today's challenges 206. Challenge generator 114 may generate the set of daily challenges based on a number of factors, discussed in more detail below.

In some embodiments, challenge generator 114 may generate the set of daily challenges based on the parents' objectives. For example, each global objective can be associated with or translated into one or more challenges. For example, a global objective “eat less sugar” can be translated into two potential challenges “eat no more than one candy today” and “avoid all sugary drinks today.” Challenge generator 114 may then add one or both of the challenges to the set of daily challenges. It will be noted that some (or all) global objectives may have a 1:1 mapping to challenges. For example, a global objective “eat at least one vegetable a day” can be associated with a single challenge “eat at least one vegetable.”

Another factor that may be considered by challenge generator 114 when generating a new set of daily challenges may be the child's past activity. For example, challenge generator 114 may determine that the child rarely accomplishes a particular challenge despite being presented the opportunity multiple (e.g., a predefined number of) times. Based on that determination, challenge generator 114 may switch to other challenges, e.g., other challenges that may achieve the same global objective. As another example, challenge generator 114 may determine that the child has accomplished a particular challenge so many times (e.g., more than a predefined threshold) that the child has likely developed a healthy habit as a result and will likely continue performing the task even without it appearing on daily challenges, i.e., without any incentives. In this case, challenge generator 114 may start adding that challenge to the daily challenges less frequently unless and until it determines that the child stopped accomplishing the challenge, in which case it may increase the frequency again in order to reinforce the habit.

In some embodiments, because the number of daily challenges can be limited, challenge generator 114 may measure and compare child user's progress toward different goals, and choose challenges based on that comparison. For example, if the child made better progress toward goal A than toward goal B, challenge generator 114 may choose more challenges associated with goal B than those associated with goal A.

In some embodiments, in determining which challenges to include in a set of daily challenge, challenge generator 114 may follow a set of predefined habit-establishing guidelines defining the minimum/average/maximum period, minimal/average/maximum frequency, and other parameters (or combination thereof) under which the child is likely to develop a habit and no longer need frequent reminders. In such a case, challenge generator 114 may determine that the child is close to or at least on track to establishing a certain habit, and based on this determination prioritize that challenge over other challenges in order to successfully complete instilling the particular habit.

In some embodiments, challenge generator 114 may also take into account one or more of the user characteristics of the child user defined by the parent user, as discussed above. For example, challenge generator 114 may choose challenges based on the child user's age, gender, nutritional preferences, nutritional restrictions, etc. In some embodiments, each challenge may be associated with a predefined set of appropriate child characteristics that the child user must have (e.g., must be 9 or older, must not have peanut allergies, etc.), and challenge generator 114 may not choose a challenge if the child user does not possess all of the characteristics associated with the challenge.

In some embodiments, challenge generator 114 may generate challenges by selecting a subset of challenges from a large set of challenges stored, for example, in a memory or a database located on or accessible by server 110. In some embodiments, each challenge may be stored in association with various parameters, such us a set of appropriate child characteristics, health parameters (discussed below), corresponding user objective(s), default number of points, and any other parameters associated with the challenge. In some embodiments, some or all of these parameters can be modifiable by the parent user associated with the child user.

In some embodiments, challenge generator 114 may measure the child user's progress toward one of the defined global objectives based on the child's past activity, using any suitable progress metric or formula. Furthermore, in some embodiments, challenge generator 114 may use machine learning/artificial intelligence techniques, including deep learning techniques (e.g., artificial neural networks) to determine which challenges work better, i.e., result in better progress toward a certain global objective.

In some embodiments, as illustrated in FIG. 2B, when a child user believes he or she has accomplished one of today's challenges 206, they can select (e.g., touch) widget 207. In response to this input, a dialog window 209 can be displayed, asking the child user to confirm that the challenge has been accomplished. In some embodiments, the child user may be required to produce evidence of the accomplishment, e.g., by recording and attaching photo or video proof. In some embodiments, the proof may not be required and be optional, allowing the child user to earn additional points if he or she provides the proof.

In some embodiments, as illustrated in FIG. 2C, after the child user indicates accomplishment of a certain challenge, the child user may be presented (e.g., in a new educational window 211) educational material associated with the accomplished challenge. In some embodiments, the educational material may include text, imagery, audio, and/or video content that can be, for example, embedded into the user interface or accessed by the user child through a link 212. In some embodiments, completing (e.g., reviewing, watching, etc.) the educational material can be required in order to earn the points associated with the original challenge. In other embodiments, the points can be automatically added to the child user's balance when the child indicates accomplishing the challenge, whereas reviewing the educational material can be optional and can earn the child user additional points. In further embodiments, to effectively complete an educational material (and obtain points associated therewith), the user child may be required to successfully pass a test (i.e., answer some questions) related to the educational material.

Educational material associated with the various challenges can be automatically selected by educational material selector 116. Educational material selector 116 may access, for example, a database or a memory containing a plurality of education contents (videos, images, texts, games, or any other type of educational material) and select one of those contents, for example, based on how relevant the content is to the particular challenge and/or based on whether and when the child already saw that content. In some embodiments, educational material selector 116 may also determine, based on the child user's past activity, which educational material would be more effective and choose that content over alternative contents. For example, if in the past the child made better progress after watching a video than after reading a text, selector 116 may prioritize showing video content over text content going forward. In some embodiments, selector 116 may choose content based also on the user characteristics of the child user, such us the child user's age, gender, and so forth.

In some embodiments, educational material may not be associated with any daily challenge, and may be presented independently, for example, as a daily challenge in and of itself, the completion of which can earn the user child a predefined number of points.

FIG. 2D shows an exemplary “wallet” screen that includes various rewards earned or in progress of being earned by the child user. Such rewards include, for example, earned product rewards 215 (e.g., 215A, 215B, and 215C) and earned non-product rewards 213 (e.g., 213A and 213B). In some embodiments, for each earned product reward 215, a requested date and a status can be provided, the status indicating, for example, whether and when the reward has been approved by the parent user, whether and when it was shipped, and whether and when it was received.

FIG. 2E shows an exemplary “store” screen. In this example, the “store” screen has three additional sub-tabs 205. Selecting the “gifts” sub-tab shows the child user a plurality of available product rewards 217 and their associated values. As indicated in FIG. 2E, in some embodiments, the child user can only request product rewards 217 whose value is equal or less than the total number of points accrued by the user (shown unshaded). In some examples (not shown for brevity), a third-party online store application may be embedded into the “store” screen (e.g., using public APIs provided by the third-party online store), allowing the child user to open the third-party online store and select the desired product reward that was not included in the “gifts” sub-tab. The selected product reward can then be added to the store (e.g., to the “wish list” sub-tab depicted in FIG. 2G). Selected product's point value can be automatically calculated based on the selected product's monetary value, and the child user can request the selected product when he or she accrues the required number of points.

FIG. 2F illustrates an exemplary “store” screen where the “goodies” sub-tab is selected. In this screen, a plurality of available non-product rewards 218 are shown, where the child user can only request non-product rewards 218 whose value is equal or less than the total number of points accrued by the user (shown unshaded).

In some embodiments, when the child user selects one of the available product or non-product rewards whose value is equal or below the child user's total accrued points, the mobile app sends a reward request to application server engine 112, which pushes a notification about the reward request to the parent user associated with the child user, and/or presents such a notification the next time the parent user logs into the mobile app. While the request is pending, the child user's total number of accrued points can be reduced by the value of the requested reward, and the requested reward can appear in the “wallet” screen, as discussed above.

Upon reviewing the reward request, the parent user can deny or approve the request. Either way, the child user is notified about the parent user's decision (e.g., the decision is pushed or otherwise communicated to the child user through application server engine 112) and the status of the requested reward in the “wallet” screen can be updated accordingly. If the request is denied, the child user's total number of accrued points is restored to the pre-request value. If the request is approved, however, in some embodiments, the requested reward can be automatically ordered from a third-party website (e.g., www.amazon.com). The order can be placed by mobile device 112 of the parent user, which can communicate with the third-party website through network 114 either directly or through application server engine 112 of server 110. In either case, in some embodiments, the order can be placed automatically without any additional involvement by the parent user, where all the information required for the purchase (e.g., parent user's name, address, and credit card information) can be stored on mobile device 120 or on server 110. In other embodiments, the parent user may need to provide or verify some of the necessary information before the order can be placed. In yet other embodiments, upon obtaining the parent user's approval the reward request, the mobile app can cause mobile device 120 to automatically open another application (e.g., a browser application) and automatically direct that application to the requested reward page on the third-party website, enabling the parent user to quickly order the reward directly on the third-party website.

FIG. 2H shows an exemplary “chat” screen. In some embodiments, the “chat screen” can show messages automatically generated by chatbot engine 118, as discussed in more detail below. When a new message is generated, the child user can get a notification, prompting him or her to switch to the chat screen. In some embodiments, the automatically generated messages can include questions to the child user, which the child user can answer either using free text or by choosing from a predefine set of answers. The automatically generated messages can also include media content (e.g., photos, videos, audio files, etc.) that can be embedded or linked to via a hyperlink.

In some embodiments, based on the child's answers and other activity, chatbot engine 118 can automatically generate follow-up communications. Through these communications, the child user can learn more about various topics related to the global objectives. In addition, the communications can provide crucial information about the child's progress and preferences. That information can be utilized, for example, by challenge generator 114 to select new (e.g., more effective) challenges and/or by educational material selector 116 to select other (e.g., more effective) educational material.

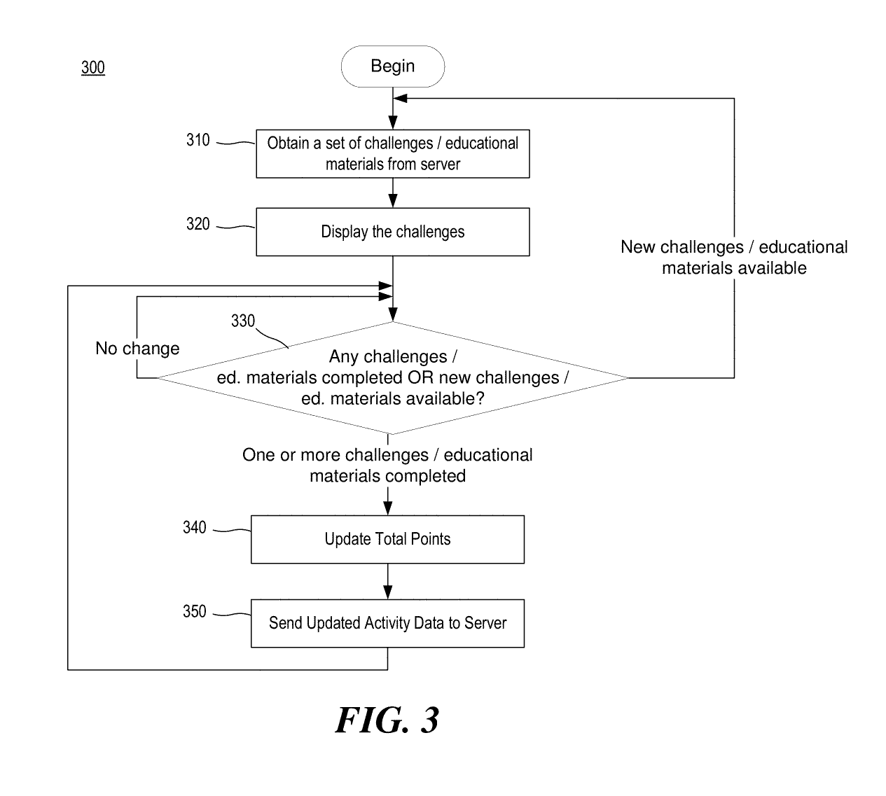

FIG. 3 illustrates, at a high level, an exemplary method 300 that can be performed, for example, on a mobile device 120 of a child user. As discussed above, the method may include obtaining (310) a set of challenges and/or educational materials from a server (e.g., 110); displaying (320) the challenges/materials, determining (330) whether any of the displayed challenges/materials have been completed and/or whether new challenges/materials are available from the server. Upon a determination that one or more challenges/materials have been completed, the method may include updating (340) the total points associated with the child user accordingly, and sending (350) updated activity data reflecting the completion to the server. Upon a determination that new challenges/materials are available, the method can loop back to step 310.

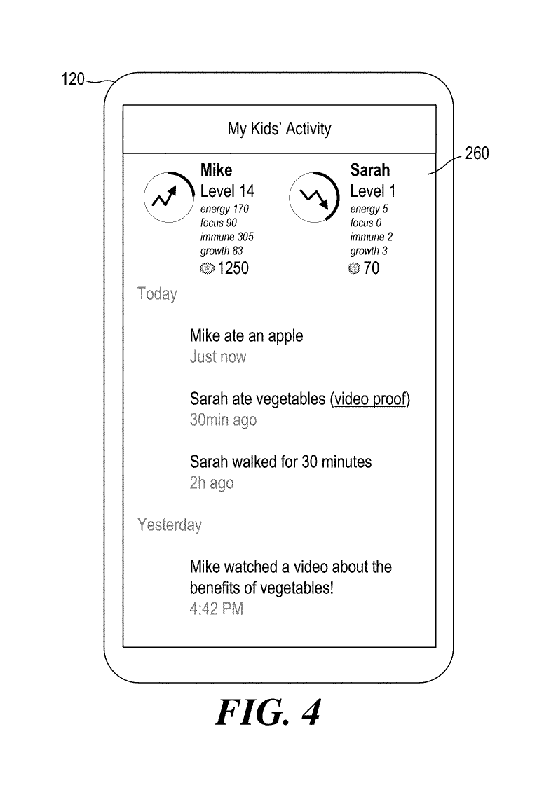

FIG. 4 shows an exemplary screen of a parent user interface 260 seen by a parent user, for example, when the parent user logs into the mobile application after having set up two child accounts for the parent user's two children, Mike and Sarah. As illustrated in FIG. 4, the parent user can see each child's daily activities (e.g., various daily challenge accomplishments and proofs thereof where available), total accrued points, as well as each child user's overall progress toward achieving the global objectives set for that child user.

In some embodiments, the child's progress can be measured using predefined health parameters, such as energy, focus, immune system, growth, etc. For example, each daily challenge can be associated with a set of health values estimating what effect completing the challenge would have on each of the health parameters. For example, a particular challenge may be said (predefined) to boost energy by 5 units, boost focus by 3 units, have no effect on the immune system (0 units), and boost growth by 1 unit, while another challenge may be associated with a completely different set of values. In these embodiments, each time a child user accomplishes a challenge, his or her total health parameters would be updated in accordance with that challenge's health values. In some embodiments, health values of each challenge and/or the total health values achieved by the child user can be visible to the child user and/or the associated parent user. In some embodiments, an overall level may be calculated for the child user based, for example, on that user's total health values, total accrued points, the number of days the child was actively using the mobile app, or any combination of these and various other factors. In some embodiments, upon achieving certain (predefined) levels, the child user may automatically be awarded bonus points, additional gifts can be “unlocked” and appear in the store, or other benefits can be gained.

It will be apparent to a person skilled in the art that all methods and systems described herein (e.g., server 110, engines 112, 114, 116, and 118, child database 150, mobile devices 120, etc.) can each be implemented as any combination of hardware and/or programming. The programming may include, for example, executable instructions stored on a tangible, non-transitory computer-readable medium. The hardware may include, for example, a processing resource for executing those instructions. The processing resource (not shown in FIG. 1 for brevity) may include, for example, one or more processors, such as central processing units (CPUs), semiconductor-based microprocessors, graphics processing units (GPUs), field-programmable gate arrays (FPGAs) configured to retrieve and execute instructions, or other electronic circuitry, which may be integrated in a single device or distributed across devices. The computer readable medium can be implemented as one or more memories communicatively coupled to the programming resource and storing program instructions that when executed by the processor resource implement the functionality of the respective component. The computer readable medium may be integrated in the same device as the processor resource or it may be separate but accessible to that device and the processor resource. In some embodiments, the program instructions can be part of an installation package that when installed can be executed by the processor resource to implement the corresponding component. In this case, the computer readable medium may be a portable medium such as a CD, DVD, or flash drive or a memory maintained by a server from which the installation package can be downloaded and installed. In another embodiment, the program instructions may be part of an application or applications already installed, and the computer readable medium may include integrated memory such as a hard drive, solid state drive, or the like.

1. A server computing system comprising:
a challenge generator configured to:
generate a set of challenge items for a child user based at least on i) a set of one or more global objectives defined for the child user by a parent user associated with the child user, and/or ii) past activity data associated with the child user;
an educational material selector configured to:
select for the child user at least one educational material from a set of educational materials based on the set of global objectives and/or the past activity data;
an application server engine configured to:
send the selected educational material and/or the generated set of challenge items to a first computing device running a first instance of a client application, the first instance of the client application being accessible by the child user, and
obtain, from the first computing device, new activity data of the child user, at least some of the new activity data corresponding to the set of challenge items and/or the selected educational material.

2. The server system of claim 1, wherein the new activity data comprises an indication of completion by the child user of at least one of the challenge items or the educational materials.

3. The server system of claim 1, wherein the application server engine is further configured to generate a different set of challenge items and/or a different set of educational materials based on the obtained new activity data.

4. The server system of claim 3, wherein the application server engine is further configured to send the different set of challenge items and/or a different set of educational materials to the first computing device.

5. The server system of claim 1, wherein the application server engine is further configured to send a summary of the new activity data to a second computing device running a second instance of the client application, the second instance being associated with the parent user.

6. The server system of claim 1, wherein the application server engine is further configured to:
obtain from the first computing device a reward request indicating a requested reward;
forward the reward request to the second computing device; and
upon receiving from the second computing device a reward response indicating approval of the reward request, automatically submitting an order for the requested reward through a third-party website.

7. A computing device comprising:
a display;
one or more processors; and
a non-transitory computer-readable medium storing instructions which, when executed by the one or more processors, cause the computing device to perform operations comprising:
obtaining from a server system a set of challenge items generated based at least in part on past activity data associated with a user;
displaying the set of challenge items on the display;
upon receiving from the user a completion input indicating completion of one of the challenge items, updating a total number of points associated with the user based on a number of points associated with the completed challenge item;
displaying on the display a plurality of potential rewards; and
upon receiving from the user a selection input identifying a selected reward from the plurality of potential rewards, sending to the server system a reward request identifying the selected reward.

8. The computing device of claim 7, wherein the operations further comprise:
receiving, from the server system, an acceptance notification indicating that another user associated with the user has accepted the selected reward; and
displaying the acceptance notification on the display.

9. The computing device of claim 7, wherein displaying the plurality of potential rewards comprises highlighting those rewards whose value does not exceed the value of the total number of points associated with the user.

10. The computing device of claim 7, wherein the operations further comprise:
obtaining from the server system an educational material generated based at least in part on the past activity data associated with the user;
presenting the educational material on the display; and
updating the total number of points associated with the user after determining that the user has learned the educational material.

11. The computing device of claim 10, wherein determining that the user has learned the educational material comprises obtaining from the user one or more answers to one or more questions associated with the educational material.

12. A non-transitory computer-readable medium storing instructions which, when executed by the one or more processors of a computing device, cause the computing device to perform operations comprising:
obtaining from a server system a set of challenge items generated based at least in part on a set of one or more global objectives defined for a user and at least some past activity data reported by the user;
displaying the set of challenge items on the display;
upon receiving from the user an input indicating completion of at least a subset of the set of challenge items, sending activity data indicating the completion to another computing device;
after sending the activity data to the other computing device, receiving from the other computing device a new set of challenge items and displaying the new set of challenge items on the display.

13. The non-transitory computer-readable medium of claim 12, wherein the set of challenge items is generated based also on characteristics of the user, the characteristics comprising at least one of: the user's age, gender, and dietary restrictions.
